(19) United States
(12) Patent Application Publication
(10) Pub. No.: US 2020/0164646 A1
(43) Pub. Date: May 28, 2020

(54) THERMAL BUBBLE INKJET PRINT HEAD CHIP AND MANUFACTURING METHOD THEREFOR

(71) Applicant: SHANGHAI AUREFLUIDICS TECHNOLOGY CO., LTD, Shanghai (CN)

(72) Inventors: Yimin GUAN, Shanghai (CN); Xiaowei WANG, Shanghai (CN); Hua ZHANG, Shanghai (CN)

(21) Appl. No.: 16/480,981

(22) PCT Filed: May 24, 2017
(86) PCT No.: PCT/CN2017/085621

§ 371 Date: Jul. 25, 2019

(30) Foreign Application Priority Data
Dec. 29, 2016 (CN) 201611248257.4

(51) Int. Cl. B41J 2/14; B41J 2/16

(52) U.S. Cl. CPC B41J 2/14112; B41J 2/1408; B41J 2/1601; B41J 2/1626; B41J 2/1606

(57) ABSTRACT

A thermal bubble inkjet print head chip has a substrate (11), a heating resistor (12) formed at a first side of the substrate, and an ink accommodating cavity (13) formed at one side of the heating resistor distant from the substrate. A low heat conduction cavity (14) is formed in the substrate; the low heat conduction cavity is located at one side of the heating resistor distant from the ink accommodating cavity; the low heat conduction cavity is filled with a material having a heat conduction efficiency lower than the substrate. By means of the low heat conduction cavity, the amount of heat generated by the heating resistor and diffusing to the substrate is reduced, and the heating efficiency of the heating resistor is improved; therefore, the working current of the heating resistor can be correspondingly lowered.

### TECHNICAL FIELD

The invention relates to the field of printing technology, particularly relates to a thermal bubble inkjet print head chip and its fabrication method.

### BACKGROUND ART

Thermal bubble inkjet print head chips of high-speed digital wide-format printing machines are widely used because they have advantages, such as mass production, high resolution and low cost, etc. The working principle is that microresistors of the thermal bubble inkjet print head chips, through which high current flows, generate a large amount of heat in a very short time, so that ink in the region of the resistors evaporates instantaneously to form bubbles and expand rapidly, which force the ink to be ejected.

In order to further increase the integrated print widths of the wide-format printing machines, up to several amps of current needs to be applied to the print heads, causing high manufacturing costs and costs-in-use of the printing machines. In addition, the temperature of the circuit elements in the print heads rise rapidly as high current flows through the circuit elements, and the performances are harmed, thus influencing the printing quality. To ensure the printing quality, print heads should be used periodically.

To solve the above problems, it is essential to provide a print head chip, which can increase the integrated print widths of digital wide-format printing machines, and reduce the operating current of the print heads and the rate of temperature increase in the substrates simultaneously, thereby increasing the printing speed of the high-speed digital wide-format printing machines.

### DETAILED DESCRIPTION OF THE INVENTION

The present invention provides a thermal bubble inkjet print head chip and its fabrication method, in order to achieve increasing integrated print width of a digital wide-format printing machine, and reducing operating current of circuit components in a print head and rate of temperature increase in a substrate simultaneously, thereby increasing printing speed of a high-speed digital wide-format printing machine.

In a first aspect, an embodiment of the present invention provides a thermal bubble inkjet print head chip, comprising:

a substrate;

a heating resistor that is formed on a first side of the substrate, and an ink chamber that is formed on a side of the heating resistor away from the substrate;

wherein, a chamber of low thermal conductivity is formed in the substrate, the chamber of low thermal conductivity being located on a side of the heating resistor away from the ink chamber, and the chamber of low thermal conductivity being filled with material having lower thermal conductivity than that of the substrate.

Optionally, in the print head chip, the chamber of low thermal conductivity is filled with material having a thermal conductivity less than 0.5 wm⁻¹K⁻¹.

Optionally, in the print head chip, a composite thin layer is arranged between the heating resistor and the chamber of low thermal conductivity.

Optionally, in the print head chip, a drive control circuit is also formed on the first side of the substrate for driving the heating resistor.

Optionally, in the print head chip, it further comprises:

an encapsulation layer that covers the drive control circuit and the heating resistor, the ink chamber that is formed on the side of the heating resistor away from the substrate, and a nozzle that forms the ink chamber.

In a second aspect, an embodiment of the present invention provides a fabrication method of the thermal bubble inkjet print head chip, comprising:

providing a substrate;

forming a heating resistor on a first side of the substrate, and forming an ink chamber on a side of the heating resistor away from the substrate;

and forming a chamber of low thermal conductivity in the substrate, the chamber of low thermal conductivity being located on a side of the heating resistor away from the ink chamber, and the chamber of low thermal conductivity being filled with material having lower thermal conductivity than that of the substrate.

Optionally, in the above fabrication method, the forming of the chamber of low thermal conductivity in the substrate comprises:

forming at least two microchambers on a second side of the substrate;

forming the chamber of low thermal conductivity in the substrate via the at least two microchambers.

Optionally, in the above fabrication method, the forming of the at least two microchambers on the second side of the substrate comprises:

forming a hard mask layer on the second side of the substrate;

forming the at least two microchambers on the substrate by using the hard mask layer.

Optionally, in the above fabrication method, the forming of the at least two microchambers on the substrate by using the hard mask layer comprises:

etching the hard mask layer by using a reactive ion etching process, and etching the substrate to form the at least two microchambers by using a deep reactive-ion etching process.

Optionally, in the above fabrication method, the forming of the chamber of low thermal conductivity in the substrate via the at least two microchambers comprises:

etching the substrate via the at least two microchambers to form the chamber of low thermal conductivity by using xenon difluoride as an etching gas.

Embodiments of the present invention provide a thermal bubble inkjet print head chip and its fabrication method, wherein the print head chip comprises a substrate; a heating resistor that is formed on the first side of the substrate, and an ink chamber that is formed on the side of the heating resistor away from the substrate; wherein, a chamber of low thermal conductivity is formed in the substrate, the chamber of low thermal conductivity being located on a side of the heating resistor away from the ink chamber, and the chamber of low thermal conductivity being filled with material having lower thermal conductivity than that of the substrate, so that the diffusion of heat generated by the heating resistor to the substrate is reduced, i.e., the heat is kept in the ink chamber, which increases the heating efficiency of the heating resistor, and thus the operating current of the heating resistor can be correspondingly reduced. It achieves increasing integrated print width of a digital wide-format printing machine, and reducing operating current of a print head and rate of temperature increase in a substrate simultaneously, thereby increasing printing speed of a high-speed digital wide-format printing machine.

### DESCRIPTION OF THE DRAWINGS

FIG. 1 is a schematic diagram of a thermal bubble inkjet print head chip provided in the first embodiment of the present invention;

FIG. 2 is a schematic diagram of another thermal bubble inkjet print head chip provided in the first embodiment of the present invention;

FIG. 3 is a fabrication method of a thermal bubble inkjet print head chip provided in the second embodiment of the present invention;

FIG. 4 is a fabrication method of a thermal bubble inkjet print head chip provided in the third embodiment of the present invention;

FIG. 5 is a schematic diagram of a thermal bubble inkjet print head chip corresponding to step 320 in FIG. 4;

FIG. 6 is a schematic diagram of a thermal bubble inkjet print head chip corresponding to step 330 in FIG. 4.

### EMBODIMENTS

Hereinafter, the present invention is further described in detail with reference to the drawings and the embodiments. It should be understood that the embodiments described herein are used only to illustrate the present invention, but not to limit the scope of the present invention. In addition, it should also be noted that, for ease of description, only parts of the structures related to the present invention are shown in the drawings, not all of them.

### Embodiment 1

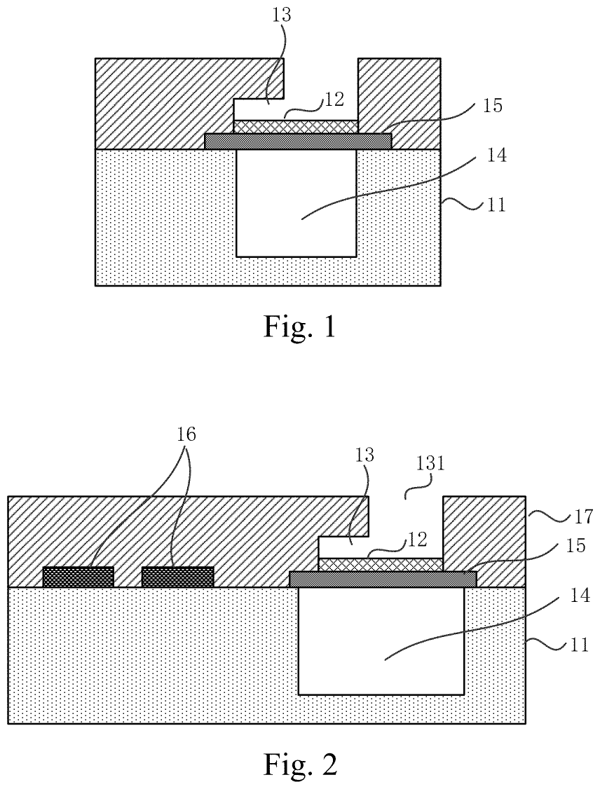

FIG. 1 is a schematic diagram of a thermal bubble inkjet print head chip provided in the first embodiment of the present invention. Referring to FIG. 1, the print head chip comprises substrate 11, heating resistor 12, ink chamber 13 and chamber of low thermal conductivity 14. Among them, heating resistor 12 is formed on the first side of substrate 11, and ink chamber 13 is formed on the side of heating resistor 12 away from substrate 11; wherein, chamber of low thermal conductivity 14 is formed in substrate 11, chamber of low thermal conductivity 14 being located on the side of heating resistor 12 away from ink chamber 13, and chamber of low thermal conductivity 14 being filled with material having lower thermal conductivity than that of the substrate. Specifically, by forming chamber of low thermal conductivity 14 in substrate 11 and filling chamber of low thermal conductivity 14 with material having lower thermal conductivity than substrate 11, the diffusion of heat generated by heating resistor 12 to substrate 11 is reduced, so that the temperature of the whole substrate 11 is not too high to decrease the operation performance of the whole print head chip. Additionally, because the diffusion of heat generated by heating resistor 12 to substrate 11 is reduced, the heat generated by heating resistor 12 is more concentrated in ink chamber 13 for heating ink, which corresponds to improving the utilization rate of the heat generated by heating resistor 12, and thus heating resistor 12 can also generate enough heat to heat the ink at a lower operating current.

Optionally, in the above chip, chamber of low thermal conductivity 13 is filled with material having a thermal conductivity less than 0.5 wm⁻¹K⁻¹. As an example, chamber of low thermal conductivity 13 is filled with air or epoxy resin. Because the substrate is usually made of silicone material, and the thermal conductivity of air is much smaller than that of silicone, chamber of low thermal conductivity 14 can be filled with air to prevent the heat generated by heating resistor 12 from diffusing into the substrate. Furthermore, the cost of air filling is low, and the steps in the process are also decreased. In addition, epoxy resin or other materials having thermal conductivity less than 0.5 wm⁻¹K⁻¹ can also be filled in chamber of low thermal conductivity 14, which can also indirectly increase the heating efficiency of heating resistor 12, and reduce the operating current of the print head.

Optionally, in the above chip, a composite thin layer is arranged between heating resistor 12 and chamber of low thermal conductivity 14. Referring to FIG. 1, there is also composite thin layer 15 arranged between heating resistor 12 and chamber of low thermal conductivity 14, and composite thin layer 15 may comprise many functional layers, e.g., a supporting layer for supporting components, such as heating resistor 12, etc.; a thermal insulation layer for further reducing heat diffusion of heating resistor 12; and an insulation layer, etc. It is necessary to determine which functional layers are specifically included in composite thin layer 15 according to actual needs.

Optionally, in the above chip, there is also a drive control circuit formed on the first side of the substrate for driving the heating resistor. FIG. 2 is a schematic diagram of another thermal bubble inkjet print head chip provided in the first embodiment of the present invention. Referring to FIG. 2, there is also drive control circuit 16 formed on the first side of the substrate, drive control circuit 16 being used for driving heating resistor 12, which generates heat to heat the ink.

Optionally, in the above chip, it further comprises: encapsulation layer 17, which covers drive control circuit 16 and heating resistor 12, ink chamber 14 that is formed on the side of heating resistor 12 away from substrate 11, and nozzle 131 that forms the ink chamber. Specifically, referring to FIG. 2, after the formation of drive control circuit 16 and heating resistor 12, encapsulation layer 17 is formed on the top of drive control circuit 16 and heating resistor 12, ink chamber 14 that is formed on the side of heating resistor 12 away from substrate 11, and nozzle 131 that forms the ink chamber. The heat generated when heating resistor 12 works causes ink to heat up and produce bubbles, thereby ejecting the ink from nozzle 131.

### Embodiment 2

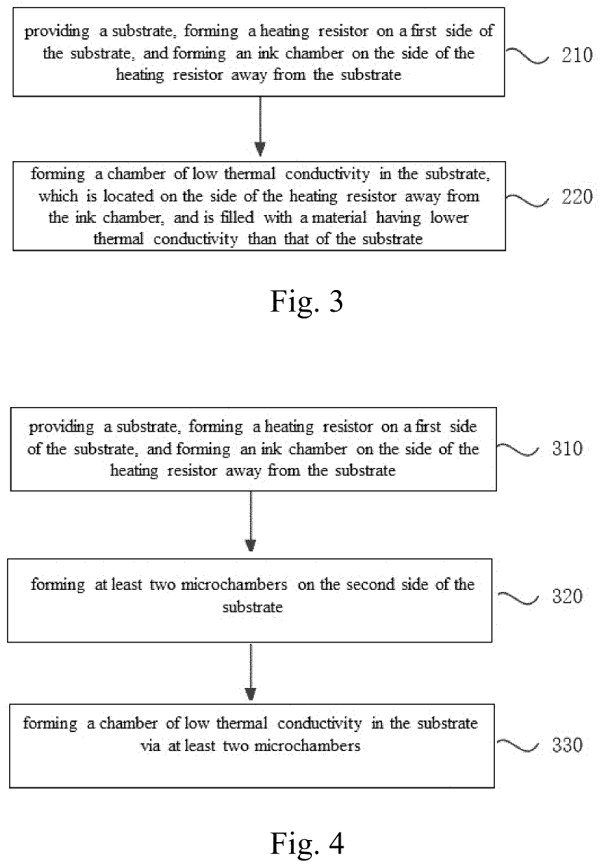

FIG. 3 is a fabrication method of a thermal bubble inkjet print head chip provided in the second embodiment of the present invention, which is suitable to the situation of reducing heat loss of the heating resistor, and improving heating efficiency. The method can be implemented with a thermal bubble inkjet print head chip configured in the printer.

Referring to FIG. 3, a fabrication method of a thermal bubble inkjet print head chip provided in the second embodiment of the present invention, specifically comprises the following steps of:

Step 210. providing a substrate, forming a heating resistor on the first side of the substrate, and forming an ink chamber on the side of the heating resistor away from the substrate.

After a substrate is provided, a heating resistor is formed on the first side of the substrate, which is used to generate heat, and an ink chamber is formed on the side of the heating resistor away from the substrate, which is used to store ink. When the heat generated by the heating resistor heats ink to a certain extent, the ink can produce bubbles to cause the ejection of the ink, thus achieving printing.

Step 210. forming a chamber of low thermal conductivity in the substrate, which is located on the side of the heating resistor away from the ink chamber, and is filled with material having lower thermal conductivity than that of the substrate.

A chamber of low thermal conductivity is formed in the substrate, the chamber of low thermal conductivity is located on the side of the heating resistor away from the ink chamber, and the chamber of low thermal conductivity is filled with material having lower thermal conductivity than that of the substrate. When the heating resistor works, the heat is generated, and blocked with the chamber of low thermal conductivity filled with the material having lower thermal conductivity than that of the substrate, to reduce heat loss of the heating resistor.

The fabrication method of a thermal bubble inkjet print head chip is provided in the embodiment of the present invention, by using the chamber of low thermal conductivity to reduce the diffusion of heat generated by the heating resistor to the substrate, so the temperature of the whole substrate being not too high to decrease the operation performance of the whole print head chip. Additionally, because the diffusion of heat generated by the heating resistor to the substrate is reduced, the heat generated by the heating resistor is more concentrated in the ink chamber for heating the ink, which corresponds to improving the utilization rate of the heat generated by the heating resistor, and thus the heating resistor can also generate enough heat to heat the ink at a lower operating current.

### Embodiment 3

FIG. 4 is a fabrication method of a thermal bubble inkjet print head chip provided in the third embodiment of the present invention. Referring to FIG. 4, based on the above embodiment, the formation of the chamber of low thermal conductivity in the substrate comprises: forming at least two microchambers on the second side of the substrate; forming a chamber of low thermal conductivity in the substrate via the at least two microchambers. That is, step 220 in the second embodiment comprises the following step 320 and step 330.

Referring to FIG. 4, a fabrication method of a thermal bubble inkjet print head chip in the embodiment specifically comprises:

Step 310. providing a substrate, forming a heating resistor on the first side of the substrate, and forming an ink chamber on the side of the heating resistor away from the substrate. Specifically, the description in step 210 of the second embodiment can be referred to.

Step 320. forming the at least two microchambers on the second side of the substrate.

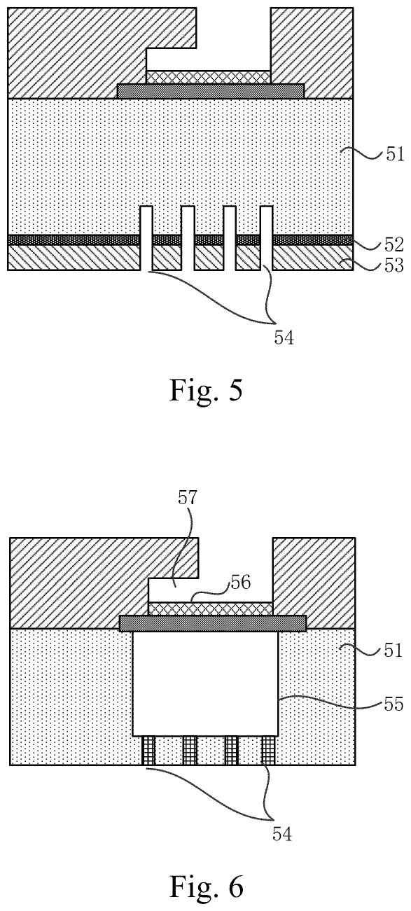

FIG. 5 is a schematic diagram of a thermal bubble inkjet print head chip corresponding to step 320 in FIG. 4. Referring to FIG. 5, the at least two microchambers 54 are formed on the second side of substrate 51. Four microchambers 54 are schematically depicted in the figure. The number, shape and depth of the microchambers are determined according to actual needs, which are not limited here. The formation of microchambers 54 can be achieved by using appropriately chosen etching processes.

Step 320. forming a chamber of low thermal conductivity in the substrate via the at least two microchambers.

FIG. 6 is a schematic diagram of a thermal bubble inkjet print head chip corresponding to step 330 in FIG. 4. Referring to FIG. 6, chamber of low thermal conductivity 55 is formed in substrate 51 via microchambers 54, for example, by etching the substrate by using wet etching process. Chamber of low thermal conductivity 55 is located on the side of heating resistor 56 away from ink chamber 57, and chamber of low thermal conductivity 55 is filled with material having lower thermal conductivity than that of substrate 51.

The fabrication method of a thermal bubble inkjet print head chip is provided in the embodiment of the present invention, by using the at least two microchambers to form a chamber of low thermal conductivity in the substrate, and reducing the diffusion of heat generated by the heating resistor to the substrate, so that the temperature of the whole substrate is not too high to decrease the operation performance of the whole print head chip. Additionally, because the diffusion of heat generated by the heating resistor to the substrate is reduced, the heat generated by the heating resistor is more concentrated in the ink chamber for heating the ink, which corresponds to improving the utilization rate of the heat generated by the heating resistor, and thus the heating resistor can also generate enough heat to heat the ink at a lower operating current.

Optionally, in the above fabrication method, the at least two microchambers are formed on the second side of the substrate comprises:

forming a hard mask layer on the second side of the substrate; forming the at least two microchambers on the substrate by using the hard mask layer. Specifically, referring to FIG. 5, hard mask layer 52 is firstly formed on the second side of substrate 51 to be used for protecting substrate 51, and protecting the substrate except microchambers 54 during the formation of microchambers 54.

Optionally, in the above fabrication method, the forming of the at least two microchambers on the substrate by using the hard mask layer comprises: etching the hard mask layer by using a reactive ion etching process, and etching the substrate to form the at least two microchambers by using a deep reactive-ion etching process.

Optionally, in the above fabrication method, the formation of a chamber of low thermal conductivity in the substrate via the at least two microchambers comprises: etching the substrate via the at least two microchambers to form the chamber of low thermal conductivity by using xenon difluoride (XeF₂) as an etching gas. Specifically, after the at least two microchambers are formed, the substrate is further etched to form the chamber of low thermal conductivity in the substrate by using xenon difluoride (XeF₂) as an etching gas. In addition, polycrystalline silicone can be filled in the microchambers of the substrate to seal the chamber of low thermal conductivity, and other heat dissipation materials can be used, preferably having low thermal expansion coefficients and low thermal stresses characteristics simultaneously.

It should be noted that the thermal bubble inkjet print head chip device provided in the embodiments of the present invention can be used to implement the fabrication methods of the thermal bubble inkjet print head chips provided in the embodiments of the present invention, which have corresponding functions and beneficial effects.

Note that the above are only better embodiments and the applied technical principles of the present invention. It will be understood by those skilled in the art that the present invention is not limited to the specific embodiments described herein, and that for those skilled in the art, various obvious changes, readjustments and alternations can be made without departing from the scope of protection of the present invention. Therefore, although the invention has been illustrated in more detail with the above embodiments, the invention is not limited to the above embodiments, it can also include more equivalent embodiments without departing from the concept of the present invention, and the scope of the invention is determined by the scope of the appended claims.

1. A thermal bubble inkjet print head chip comprising:
a substrate;
a heating resistor that is formed on a first side of the substrate, and an ink chamber that is formed on a side of the heating resistor away from the substrate;
wherein, a chamber of low thermal conductivity is formed in the substrate, the chamber of low thermal conductivity being located on a side of the heating resistor away from the ink chamber, and the chamber of low thermal conductivity being filled with material having lower thermal conductivity than that of the substrate.

2. The chip of claim 1, wherein, the chamber of low thermal conductivity is filled with material having a thermal conductivity less than 0.5 wm⁻¹K⁻¹.

3. The chip of claim 1, wherein, a composite thin layer is arranged between the heating resistor and the chamber of low thermal conductivity.

4. The chip of claim 1, wherein, a drive control circuit is further formed on the first side of the substrate for driving the heating resistor.

5. The chip of claim 4, further comprising:
an encapsulation layer that covers the drive control circuit and the heating resistor, the ink chamber that is formed on the side of the heating resistor away from the substrate, and a nozzle that forms the ink chamber.

6. A fabrication method of a thermal bubble inkjet print head chip comprising:
providing a substrate;
forming a heating resistor on a first side of the substrate, and forming an ink chamber on a side of the heating resistor away from the substrate;
and forming a chamber of low thermal conductivity in the substrate, the chamber of low thermal conductivity being located on a side of the heating resistor away from the ink chamber, and the chamber of low thermal conductivity being filled with material having lower thermal conductivity than that of the substrate.

7. The fabrication method of claim 6, wherein, the formation of the chamber of low thermal conductivity in the substrate comprises:
forming at least two microchambers on a second side of the substrate;
forming the chamber of low thermal conductivity in the substrate via the at least two microchambers.

8. The fabrication method of claim 7, wherein, the forming of the at least two microchambers on the second side of the substrate comprises:
forming a hard mask layer on the second side of the substrate;
forming the at least two microchambers on the substrate by using the hard mask layer.

9. The fabrication method of claim 8, wherein, the forming of the at least two microchambers on the substrate by using the hard mask layer comprises:
etching the hard mask layer by using a reactive ion etching process and etching the substrate to form the at least two microchambers by using a deep reactive-ion etching process.

10. The fabrication method of claim 7, wherein, the forming of the chamber of low thermal conductivity in the substrate via the at least two microchambers comprises:
etching the substrate via the at least two microchambers to form the chamber of low thermal conductivity by using xenon difluoride as an etching gas.
